(19) United States
(12) Patent Application Publication
(10) Pub. No.: US 2018/0173416 A1
(43) Pub. Date: Jun. 21, 2018

(54) DISTRIBUTED NETWORKING OF CONFIGURABLE LOAD CONTROLLERS

(71) Applicant: UBE, INC. d/b/a PLUM, AUSTIN, TX (US)

(72) Inventors: UTZ D. BALDWIN, AUSTIN, TX (US); GLEN A. BURCHERS, AUSTIN, TX (US); RICHARD M. WARWICK, AUSTIN, TX (US); DANIEL J. KUPERSZTOCH, AUSTIN, TX (US); GUY J. RAZ, AUSTIN, TX (US)

(21) Appl. No.: 15/900,487

(22) Filed: Feb. 20, 2018

Related U.S. Application Data
(63) Continuation-in-part of application No. 29/589,464, filed on Dec. 30, 2016, now Pat. No. D810701.
Application No. 29/589,464 is a continuation-in-part of application No. 14/198,279, filed on Mar. 5, 2014, now abandoned.
(60) Provisional application No. 61/773,896, filed on Mar. 7, 2013.

(51) Int. Cl. G06F 3/0488; G06F 3/01; G06F 3/0346; H05B 37/02

(52) U.S. Cl. CPC G06F 3/04883; G06F 3/017; G06F 2203/04808; H05B 37/0209; G06F 3/0346

(57) ABSTRACT

A touch-control device is described, comprising a first load controller connectable to control a first endpoint electrically coupled to the load controller; a touch-input surface associated with the first load controller; a network interface communicatively coupled with a network interface of a second touch-control device, wherein the second touch-control device includes a second load controller connectable to control a second endpoint electrically coupled to the second load controller; and a processor configured to generate a first gesture signal representative of a first gesture at the touch-input surface, select the second endpoint as a target device, the selecting based at least in part on the first gesture, and control the target device based, at least in part, on the first gesture signal.

### CROSS-REFERENCE TO RELATED APPLICATIONS

This application claims the benefit of U.S. patent application Ser. No. 29/589,464, filed Dec. 30, 2016, which claims the benefit of U.S. patent application Ser. No. 14/198,279, filed Mar. 5, 2014, which claims priority to U.S. Provisional Application No. 61/773,896, filed Mar. 7, 2013, all of which are incorporated by reference.

### BACKGROUND

The present disclosure relates to electrical load control at a location. More specifically, the present disclosure relates to user-configured load controllers for controlling one or more electrical loads.

### SUMMARY

In one embodiment, the disclosure provides a touch-control device including a load controller, a touch-input surface, a network interface, and a processor. The load controller is connectable to control a first endpoint electrically coupled to the load controller. The network interface is communicatively coupled with a network interface of a second touch-control device. The processor is configured to generate a first gesture signal and select at least one of the first and second endpoints as a target device based on the first gesture signal. The processor is further configured to generate a second gesture signal and control the target device based on the second gesture signal.

In some embodiments, the touch-control device includes a visual indicator, such as a light or display, configured to indicate the target device. The visual indicator may indicate the target device by substantially reproducing one or more of an intensity output, a color output, and a pattern of illumination of the target device. In some embodiments, the processor is further configured to control the target device and the visual indicator to output substantially similar illumination. In some embodiments, one or both of the first and second gesture signals may be user-defined gesture signals. In some embodiments, the processor is further configured to generate spatiotemporal information of the first gesture signal and select the target device based on the spatial information of the first gesture signal. In some embodiments, the processor is further configured to select at least one of the first endpoint and the second endpoint as the target device based on a user authorization or identity.

In another embodiment, the disclosure provides a system for controlling a plurality of endpoints which includes a first touch-control device, a first endpoint electrically coupled to the first touch-control device, a second touch-control device communicatively coupled with the first touch-control device, a second endpoint electrically coupled to the second touch-control device, and a processor. The processor is configured to generate a first gesture signal representative of a gesture at a touch-input surface, such as a touch-input surface of the first or second touch-control devices. The processor is further configured to select a target device based on the first gesture signal, including selecting at least one of the first endpoint and the second endpoint. The processor is further configured to generate a second gesture signal and control the target device based on the second gesture signal.

In some embodiments, the system includes a visual indicator configured to indicate the target device. The visual indicator may indicate the target device by substantially reproducing one or more of an intensity output, a color output, and a pattern of illumination of the target device. In some embodiments, both the processor and the visual indicator may be disposed in the first touch-control device. In some embodiments, either or both of the first gesture signal and the second gesture signal are user-defined gesture signals. In some embodiments, the processor is further configured to generate spatiotemporal information with a gesture signal and control the target device based on the spatiotemporal information.

In some embodiments, the processor is further configured to generate a third gesture signal and authorize a user based on the third gesture signal. In further embodiments, the selecting the target device is based on the user authorization. In some embodiments, the system further includes a plug-in control device communicatively coupled with the first touch-control device.

In some embodiments, the disclosure provides a method of controlling a plurality of endpoints, including coupling a first touch-control device with a second touch-control device, generating a first gesture signal, selecting a target device based on the first gesture signal, generating a second gesture signal, and controlling the target device based on the second gesture signal. In some embodiments, one or both of the first and second gesture signals are user-defined gesture signals. In some embodiments, the method further includes indicating the target device, including producing substantially similar illumination at the target device and a visual indicator. In these embodiments, the illumination includes one or more of an intensity output, a color output, and a pattern of illumination.

In some embodiments, the visual indicator includes a portable electronic device communicatively coupled with the first touch-control device. In some embodiments, the method further includes generating a third gesture signal which includes spatiotemporal information, and defining the third gesture signal based on the spatiotemporal information.

Other aspects of the disclosure will become apparent by consideration of the detailed description and accompanying drawings.

### BRIEF DESCRIPTION OF THE DRAWINGS

FIG. 1 is a perspective view of an in-wall touch-control device, according to some embodiments.

FIG. 2 is a block diagram of an in-wall touch-control device, according to some embodiments.

FIG. 3 is a block diagram of a plug-in control device, according to some embodiments.

FIG. 4A illustrates a tap gesture at a touch input surface, according to some embodiments.

FIG. 4B illustrates a swipe gesture at a touch input surface, according to some embodiments.

FIG. 4C illustrates a pinch or zoom gesture at a touch input surface, according to some embodiments.

FIG. 4D illustrates a single-finger continuous stroke gesture at a touch input surface, according to some embodiments.

FIG. 5A is a block diagram of a networked control device, according to some embodiments.

FIG. 5B is a block diagram of a pair of networked control devices electrically coupled to the same endpoint, according to some embodiments.

FIG. 5C is a block diagram of two networked control devices, according to some embodiments.

FIG. 6 is a block diagram of a system of networked control devices, according to some embodiments.

FIG. 7 is a perspective view of a room containing contextually aware control devices, according to some embodiments.

FIG. 8A is a block diagram of a system including at least one touch-control device and at least one portable electronic device, according to some embodiments.

FIG. 8B is a block diagram of a system including at least one portable electronic device and a pair of touch-control devices, according to some embodiments.

FIG. 8C is a block diagram if a system including at least one portable electronic device and a plurality of touch-control devices, according to some embodiments.

FIG. 9 illustrates a system, including at least one touch-control device and at least one portable touch-control device, according to some embodiments.

FIG. 10 is a perspective view of a room containing context-aware control devices and a portable electronic device, according to some embodiments.

FIG. 11 is a flow diagram of a method of selecting a target device at a touch-control device.

FIG. 12 is a flow diagram of a method of configuring an indication at a control device.

FIG. 13 is a flow diagram of a method of defining a user-configured response.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. As used herein, the word “may” is used in a permissive sense (e.g. meaning having the potential to) rather than the mandatory sense (e.g. meaning must). In any disclosed embodiment, the terms “approximately,” “generally,” and “about” may be substituted by “within a percentage of” what is specified, where the percentage includes 0.1, 1, 5, and 10 percent.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has been proven convenient at times, principally for reasons of common usage, to refer to signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, the terms “processing,” “computing,” “calculating,” “determining” or the like refer to actions or processes of a specific apparatus, such as a special purpose computer or a similar special purpose electronic computing device. In the context of this specification, therefore, a special purpose computer or similar special purpose electronic computing device is capable of manipulating or transforming signals, typically represented as physical electronic or magnetic quantities within memories, registries, or other information storage devices, transmission devices, or display devices of the special purpose computer or similar special purpose electronic computing device. The use of the variable “n” is intended to indicate that a variable number of local computing devices may be in communication with the network.

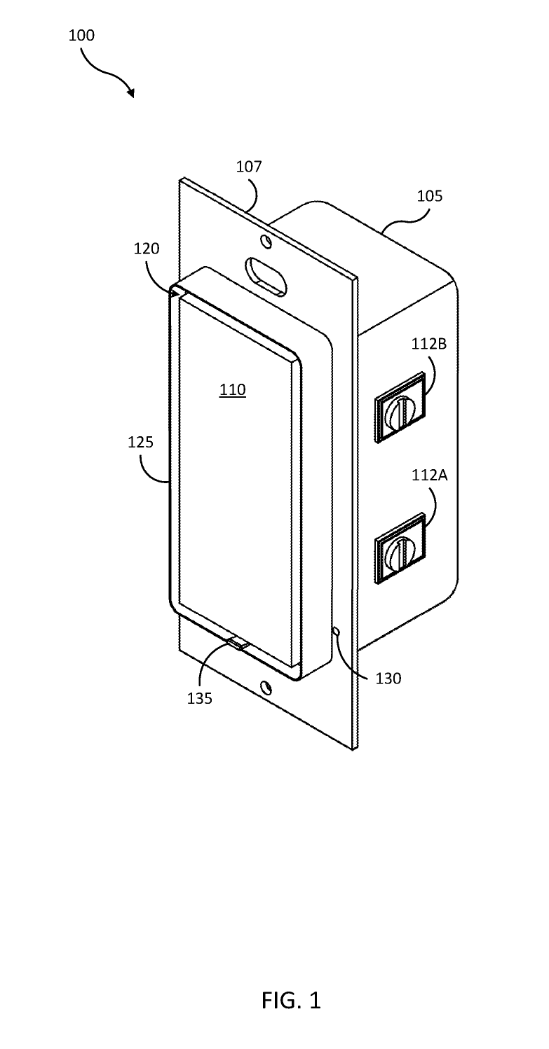

FIG. 1 illustrates an in-wall touch-control device 100, according to some embodiments. The touch-control device 100 includes a housing 105 that is preferably made from a durable, lightweight, inexpensive, and non-conductive material suitable for the environment in which the switch assembly will operate. A thermoplastic material, such as a resin, or other polymeric substances are examples of materials. The housing 105 is supported in a conventional electrical box by a yoke 107. In the illustrated embodiment, the touch-control device 100 is in a single-gang configuration, but may be configured in 2-, 3-, and 4-gang configurations, or any other suitable configuration. Supported by the housing 105, the touch-control device 100 includes an input interface or touch-input surface 110 on a front side of the housing 105. At least partially retained within the housing 105, the touch-control device 100 includes a line terminal and a load terminal, such as screw terminals 112A and 112B, respectively. Accordingly, one or more electrical loads or endpoints may be coupled to the load terminal and controlled by the touch-control device 100. For example, the touch-control device 100 may switch or attenuate power provided to an endpoint, such as to shut off or dim a light. Additionally or alternatively, the touch-control device 100 may modulate the power with a data signal, such as powerline communication, to control an endpoint, such as a smart device. U.S. Patent Publication No. 2014/0253483 (“The '483 Publication”), the entire contents of which are incorporated herein by reference, discloses further control of endpoints by a touch-control device.

The touch-control device 100 further includes a light ring or visual indicator 120. In the illustrated embodiment, the visual indicator 120 includes a plurality of LEDs and a lightpipe substantially surrounding the touch-input surface 110 within a sidewall 125. Alternatively, the visual indicator 120 may include one or more displays, such as LCD or OLED screens, reflective displays, such as electrophoretic displays, or combinations thereof. In addition to the touch-input surface 110 and the visual indicator 120, the touch-control device 100 may include a plurality of other input/output devices and sensors, such as an ambient light sensor 130 and a push-button 135. The visual indicator 120 is configured for adjustable illumination which may be varied in color, luminosity, intensity, pattern of illumination, or any other suitable characteristic. Further, the visual indicator 120 is configured for adjustable illumination in position. For example, regions of the visual indicator 120 may be illuminated differently than one another, or a first region may be illuminated in a first pattern and a second region may be illuminated in a second pattern. Alternatively, or in addition, the illumination of the visual indicator 120 may be based on, for example, a user control, a sensor input, or an operational state of an endpoint.

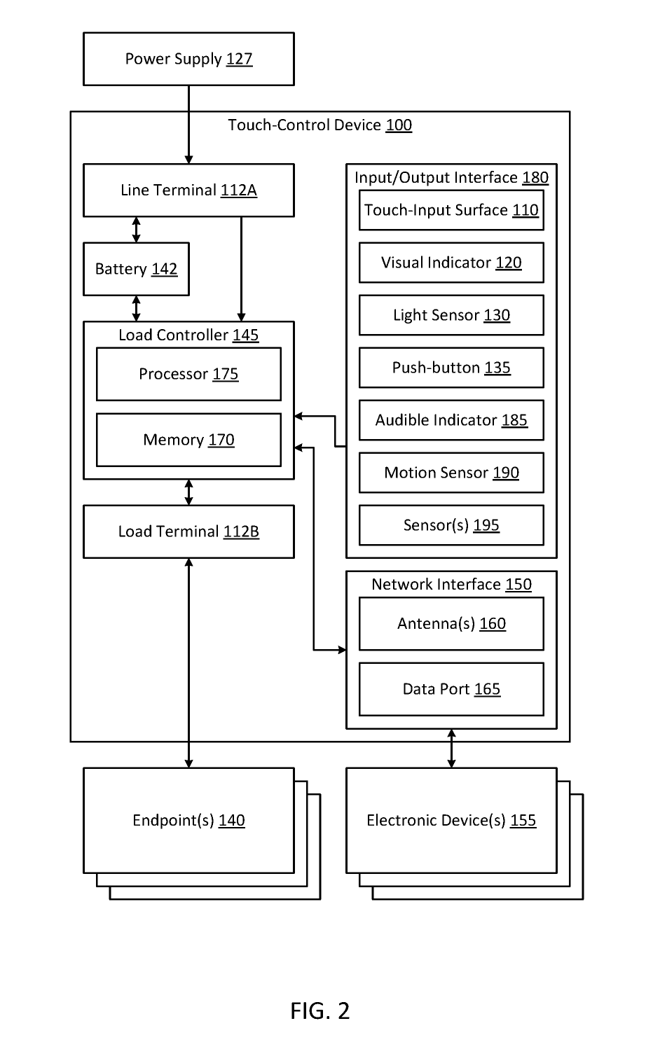

FIG. 2 diagrammatically illustrates the touch-control device 100. The touch-control device 100 receives power at the line terminal 112A from a power supply 127, such as conventional 120V AC power. The power is conducted to the load controller 145 for distribution within the touch-control device 100 as well as being provided to the load terminal 112B at a nominal voltage. The load controller 145 may include various switches, transformers, rectifiers, and other circuitry, for example, to provide low voltage DC within the touch-control device 100 as well as control the application of power provided to the load terminal 112B. The load terminal 112B is electrically coupled to one or more endpoints 140, such as lights, fans, switched receptacles, or any other electrical load. In some embodiments, the touch-control device 100 further includes a battery 142, for example, to provide emergency or temporary power to the touch-control device 100.

In addition to controlling one or more endpoints 140 which are electrically coupled at the load terminal 112B, the touch-control device 100 includes a network interface 150 configured to communicate with one or more electronic devices 155. The network interface 150 may include one or more antennas 160 configured for wireless communication, and/or one or more data ports 165 configured for wired communication. For example, the network interface 150 may include a first antenna 160 configured for communication on a first wireless network, such as Wi-Fi, and a second antenna 160 configured for communication on a second wireless network, such as a Low Power Wide Area Network (LPWAN). The network interface 150 may include a data port 165, such as an Ethernet or USB port. In some embodiments, a data port 165 is coupled to the line terminal 112A, and the network interface 150 is configured for powerline communication. Accordingly, the touch-control device 100 also is configured to control endpoints 140 which require constant power, but which are controller over wireless or wired communication, such as various smart bulbs, other smart lighting devices, LED strips, and other electronic devices electrically coupled at the load terminal 112B. In additional to directly controlling the endpoints 140, the touch-control device 100 may control endpoints indirectly through one or more electronic devices 155 in communication with the touch-control device 100. For example, the touch-control device 100 may be in communication with a second touch control device 155 which is configured to control the application of electrical power provided to one or more endpoints electrically coupled to the second touch control device 155. The touch-control device 100 transmits a control signal to the second touch control device 155, which controls the one or more endpoints, such as by halting the application of power or transmitting a wireless control signal to the one or more endpoints.

Further, the touch-control device 100 includes at least one memory 170 storing program instructions and at least one processor 175 configured to execute the program instructions stored in the memory 170. The touch-control device 100 also includes an input/output (I/O) interface 180 coupled to the processor 175 for providing a plurality of user control and feedback. The I/O interface is coupled to the touch-input surface 110, the visual indicator 120, the light sensor 130, and the push button 135. Additionally, the touch-control device may include an audible indicator 185, a motion sensor 190, GPS sensor, or any other desirable feedback devices or sensors 195. For example, the touch-control device 100 may include a vibratory or haptic feedback device, or a microphone.

Specific gestures at the touch-control device 100 can start one or more respective chains of activities (scripts) that can control endpoints 140 in manners described previously. The scripts themselves can be stored at the touch-control device 100; at respective endpoints 140; or at other convenient locations, including “in the cloud.” The activities/scripts may include other elements including, but not limited to, internal timers, conditional statements, and queries.

The occurrence of multiple gestures in relatively quick succession may be interpreted as a prefix signal indicating the beginning of a command sequence. The commands of such a sequence may be organized in a tree-like menu structure, so that the user can navigate through an internal menu of the touch-control device 100 or networked menu via the touch-control device 100.

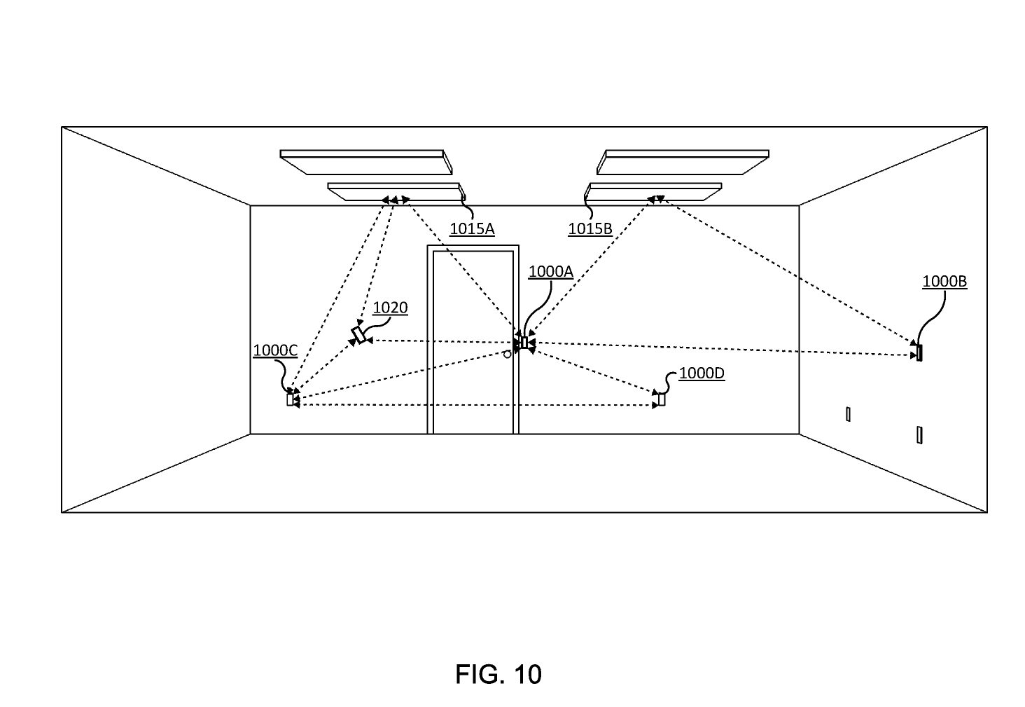

A command sequence can also indicate that the touch-control device 100 is to send commands or controls to specific endpoints 140; to send information enclosed in a command (for example, state information); or to verify a gesturer's identity. For example, verifying a gesturer's identity by detecting proximity between the touch-control device 100 and a portable electronic device (see, e.g. FIG. 10, portable electronic device 1020) associated with the gesturer. Specific sets of such multiple gestures can be processed by the touch-control device as if the user were using a one-key keyboard to type. In some embodiments, it may be desirable to have specific gestures mapped to different commands, for example, based on the identity of the user. Gestures may be used, singly or in combination, to be used to identify a user and trigger actions based on the identification. Further, it may be desirable for a user to be able to remap specific gestures to different commands, and/or create new gestures and commands.

Accordingly, the touch-control device 100 may indicate a current operational state of itself, one or more endpoints 140, or one or more electronic devices 155. Additionally, or alternatively, the touch-control device 100 may indicate one or more environmental factors, such as temperature. Further, the touch-control device 100 may provide feedback of a user selection or command. For example, the visual indicator may be selectively illuminated to act a vertical “scroll bar” when a user is interacting with a menu at the touch-control device 100. Thus, user interaction with the touch-control device 100 is improved.

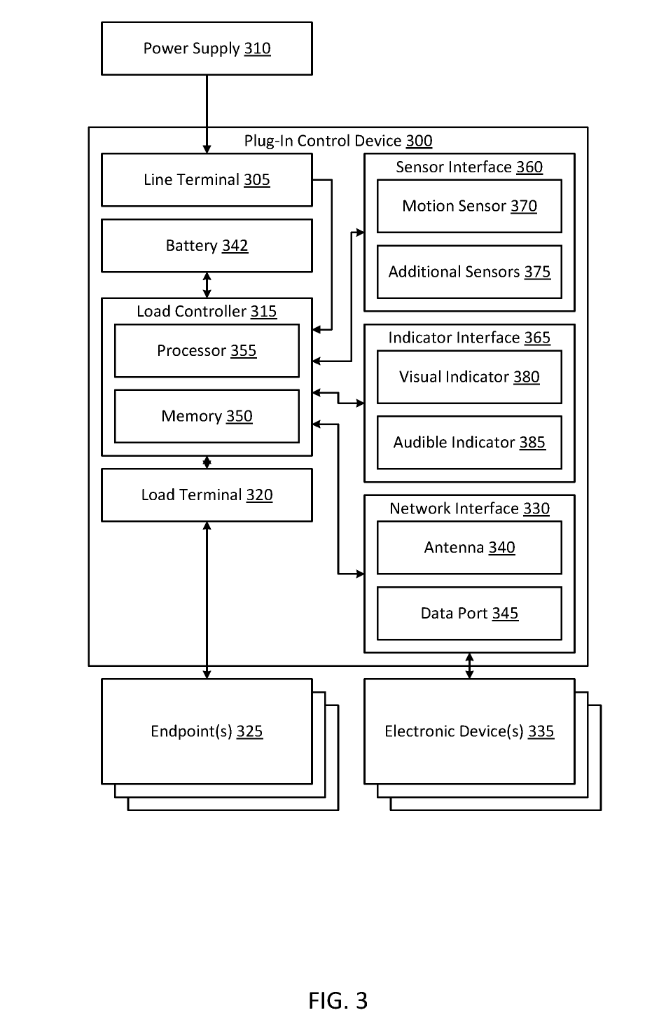

FIG. 3 diagrammatically illustrates the plug-in control device 300. The plug-in control device 300 receives power at a line terminal 305 from a power supply 310, such as conventional 120V AC power. The power is conducted to the load controller 315 for distribution within the plug-in control device 300 as well as being provided to a load terminal 320 at a nominal voltage. The load controller 315 may include various switches, transformers, rectifiers, and other circuitry, for example, to provide low voltage DC within the plug-in control device 300 as well as control the application of power provided to the load terminal 320. The load terminal 320 is electrically coupled to one or more endpoints 325, such as lights, fans, switched receptacles, or any other electrical load. In some embodiments, the plug-in control device 300 further includes a battery 342, for example, to provide emergency or temporary power to the plug-in control device 300. In some embodiments, the plug-in control device 300 is configured to act as a nightlight or flashlight by supplying energy from the battery 342 to a visual indicator 380 when the plug-in control device loses power from the power supply 310 or when it is unplugged.

In addition to controlling one or more endpoints 325 which are electrically coupled at the load terminal 320, the plug-in control device 300 includes a network interface 330 configured to communicate with one or more electronic devices 335. The network interface 330 may include one or more antennas 340 configured for wireless communication, and/or one or more data ports 345 configured for wired communication. For example, the network interface 330 may include a first antenna 340 configured for communication on a first wireless network, such as Wi-Fi, and a second antenna 340 configured for communication on a second wireless network, such as a Low Power Wide Area Network (LPWAN). The network interface 330 may include a data port 345, such as an Ethernet or USB port. In some embodiments, a data port 345 is coupled to the line terminal 305, and the network interface 330 is configured for powerline communication. Accordingly, the plug-in control device 300 is also configured to control endpoints 325 which require constant power, but which are controller over wireless or wired communication, such as various smart bulbs and other electronic devices electrically coupled at the load terminal 320. In additional to directly controlling the endpoints 325, the plug-in control device 300 may control additional endpoints indirectly through one or more electronic devices 335 in communication with the plug-in control device 300.

Further, the plug-in control device 300 includes at least one memory 350 storing program instructions and at least one processor 355 configured to execute the program instructions stored in the memory 350. The plug-in control device 300 also includes a sensor interface 360 and an indicator interface 365. The sensor interface 360 includes a motion sensor 370, but may include additional sensors 375 as desired, such as various infrared sensors, GPS sensors, ambient light sensors, carbon monoxide sensors, microphones, and the like. The indicator interface 365 includes the visual indicator 380 and an audible indicator 385. The visual indicator 380 includes a plurality of LEDs and a light pipe generally disposed about plug-in control device 300, such as on a front surface or about a plurality of side surfaces of the plug-in control device 300. Alternatively, the visual indicator 380 may include one or more displays, such as LCD or OLED screens, reflective displays, such as electrophoretic displays, or combinations thereof. The visual indicator 380 is configured for adjustable illumination which may be varied in color, luminosity, intensity, pattern of illumination, or any other suitable characteristic. Further, the visual indicator 380 is configured for adjustable illumination in location. For example, regions of the visual indicator 380 may be illuminated differently than one another, or a first region may be illuminated in a first pattern and a second region may be illuminated in a second pattern. Alternatively, or in addition, illumination of the visual indicator 380 may be based on, for example, a user control, a sensor input, an operational state of an endpoint 325, or an operational state of an endpoint or electronic device 335.

Additionally, the plug-in control device 300 may include an audible indicator 385, such as a speaker or buzzer. Accordingly, the plug-in control device 300 may indicate a current operational state of itself, one or more endpoints 325, or one or more endpoints or electronic devices 335. For example, the audible indicator 385 may be controlled to give feedback on a gesture or operational state (e.g. “the light is on”). Additionally, or alternatively, the plug-in control device 300 may indicate one or more environmental factors, such as temperature. Further, the plug-in control device 300 may provide feedback of a user selection or command. Thus, user interaction with the plug-in control device 300 is improved.

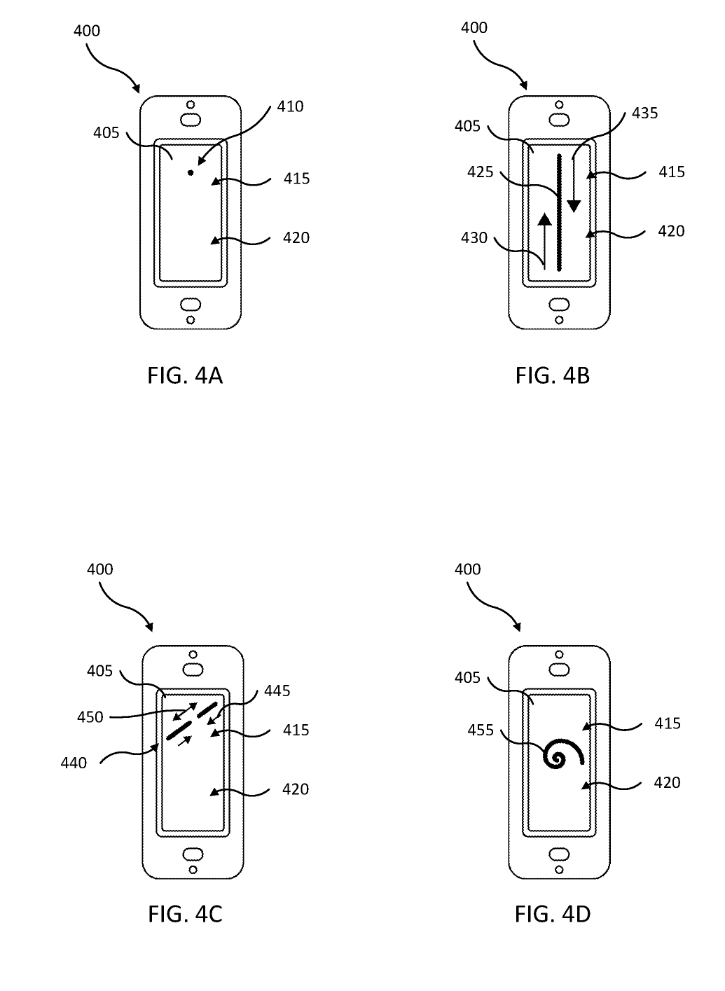

FIG. 4A illustrates a tap gesture 410 on a touch-input surface 405 of a touch-control device 400. Traditionally, a tap gesture 410 has been treated similar to a momentary contact switch where the only information recorded is whether or not a tap has occurred. Although there may be only a single point of contact in the tap gesture 410, this fails to account for additional information that may be captured or communicated with a tap gesture 410. For example, a representation of a tap gesture 410 may not only include the occurrence of the tap gesture 410, but also one or more spatial dimensions (e.g. x- and y-coordinates on the touch-input surface 405) of the tap gesture 410. Accordingly, the touch-input surface 405 may be subdivided into two or more regions, either virtually or physically, with the x- and y-coordinates being used to determine in which region the tap occurred. These regions may be user-configurable and, in some embodiments, may be dependent on context, such as a menu or state of the touch-control device 400. For example, a touch-control device 400 may be initially configured with a single region, such that the touch-control device 400 may be interacted with similarly to a conventional decora switch.

Alternatively or additionally, the representation of the tap gesture 410 may include temporal information. For example, the temporal information may include a duration (e.g. a hold), a sequence (e.g. a double tap), or any combination thereof. That is to say that, in a sequence of tap gestures 410, not only do the respective delays and locations contain useful information, but the pauses or delays between subsequent tap gestures 410 contain useful information as well. Further, these dimensions may be combined to form any suitable pattern of tap gestures 410. For example, a single tap in an upper region 415 of the touch-input surface 405 may be used to turn on a room light, whereas two sequential taps in the upper region 415 may be used to turn on all of the light lights in the room. By way of additional example, a hold gesture in a lower region 420 may be used to enter a dimming mode with subsequent tap gestures 410 in the upper region 415 selecting a dimming level.

FIG. 4B illustrates a single vertical swipe gesture 425. The swipe gesture 425 may be in an upward direction 430 or a downward direction 435, or may extend obliquely in a direction different than the generally vertical directions 430,435. A swipe gesture 425 may enable a more natural mapping of control gestures to an environment of the touch-control device 400. For example, if a user wants to indicate an endpoint to be selected as a target device to be controlled, the user may perform the swipe gesture 425 in the general direction of the desired endpoint. Similarly, a swipe gesture 425 may map naturally to one or more functional relationships, such as adjusting a speaker volume, a room temperature, or motorized blinds. However, some mappings may not extend universally to all users and may be mappings that are generally personal, situational, or cultural. Accordingly, any gesture may be configured by a user to correspond to alternative functional or positional relationships. For example, a swipe gesture 425 may be used to “scroll” through or amongst selections of endpoints.

FIG. 4C illustrates a multi-touch linear gesture 440 wherein the swipe gestures move collinearly, such as a pinch gesture 445 or zoom gesture 450. The '483 Publication further discloses other multi-touch gestures, also referred to as multi-stroke character gestures. A pinch or zoom gesture 445, 450 may also enable a more natural mapping of control gestures to various selections and interactions with the touch-control device 400, or mappings to an environment of the touch-control device 400. For example, if a user wishes to select a plurality of lights as target devices, such as exterior patio lights, a zoom gesture 450 may increase the number of lights selected as target devices, whereas a pinch gesture 445 may decrease the number of lights selected. In this example, the increase may be based on position, for example selecting all lights or endpoints in a circular region extending radially outward from the user, from the touch-control device 400, or from an endpoint, or may be based on a zone or group, such as increasing a selection of previously defined groups of lights or endpoints, such as sconce lights, pedants lights, kitchen lights, hallway lights, etc.

FIG. 4D illustrates a single-finger continuous stroke gesture 455. Although, strictly speaking, a swipe gesture may be considered a single-finger continuous stroke gesture 455, a single-finger continuous stroke gesture 455 is generally used to mean a single-finger continuous stroke gesture 455 which includes at least one non-linear component. For example, single-finger continuous stroke gestures 455 can resemble lower- and upper-case letters, as well as numbers, symbols, and other glyphs. For example, a user could be authorized in response to inputting a single-finger continuous stroke gesture 455. Any or all of the previously described gestures 410, 425, 440, 445, 450 may be combined into user-configured gestures and the mapping of these gestures 410, 425, 440, 445, 450 may also be configured by a user. For example, a user-configured gesture may include a plurality of single-finger continuous stroke gestures 455, such as a sequence of initials. As described above, the user-configured gestures may further include spatiotemporal information.

Additionally, a gesture may be used to switch between a “traditional” control mode and other control modes. For example, a touch-control device may remain in a control mode in which the touch-control device responds to gestures as a conventional switch or dimmer, until a user inputs a specific gesture to switch modes. A gesture may also be used to select a specific endpoint, regardless of which touch-control device receives the gesture. Additionally, a single gesture may be used to select and control a target device. For example, a gesture may be associated with a control action directed to an endpoint or target device. Accordingly, in response to the gesture being received at a touch-control device, the endpoint or target device is selected and the control action performed. In some embodiments, the control action is performed regardless of which touch-control device receives the gesture (e.g. regardless of whether the endpoint or target device is electrically coupled to the touch-control device). In some embodiments, the control action may be predefined, such as defined in a database, defined over a web interface, or defined by a user with a mobile application on a portable electronic device coupled to a touch-control device.

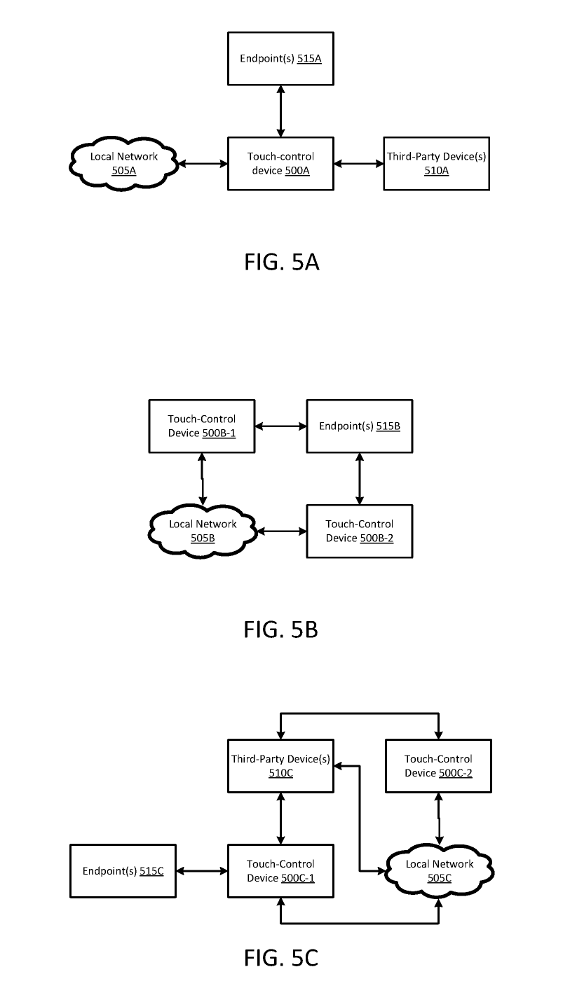

FIG. 5A illustrates one embodiment of a touch-control device 500A. The touch-control device 500A is communicatively coupled to a local network 505A, such as a Wi-Fi network, as well as one or more third-party devices 510A, such as various smart bulbs or virtual assistants. One or more endpoints 515A are electrically coupled to the touch-control device 500A. Accordingly, the touch-control device 500A is configured to control the one or more endpoints 515A based on a gesture received at the touch-control device 500A or, for example, a control signal received over the local network 505A or from one of the third-party devices 510A. Similarly, the touch-control device 500A is configured to transmit a control signal to any of the third-party devices 510A as well as over the local network 505A.

FIG. 5B illustrates an embodiment of system of touch-control devices. In this embodiment, a pair of touch-control devices 500B-1, 500B-2 is electrically coupled to the same one or more endpoints 515B. For example, a pair of touch-control devices 500B-1, 500B-2 may be configured as conventional three-way switches. Both touch-control devices 500B-1, 500B-2 are communicatively coupled to a local network 505B. Accordingly, the pair of touch-control devices 500B-1, 500B-2 is configured to control the one or more endpoints 515B based on a gesture received at either of the touch-control devices 500B-1, 500B-2 or, for example, a control signal received over the local network 505B. Similarly, the touch-control devices 500B-1, 500B-2 are configured to transmit a control signal over the local network 505B.

FIG. 5C illustrates another embodiment of a system of touch-control devices. In this embodiment, two touch-control devices 500C-1, 500C-2 are communicatively coupled to a local network 505C and one or more third-party devices 510C. The one or more third-party devices 510C are also communicatively coupled to the local network 505C. Additionally, at touch-control device 500C-1 is electrically coupled to one or more endpoints 515C. Accordingly, the one or more endpoints 515C may be controlled based on a gesture received at either of the touch-control devices 500C-1, 500C-2. For example, after a gesture is received at the touch-control device 500C-2, a control signal is transmitted via the local network 505C to the touch-control device 500C-1 to control the one or more endpoints 515C.

Additionally, the connections amongst the touch-control devices 500, one or more third-party devices 510, and the local network 505 may provide improved network resiliency. For example, in the case that the local network 505 is unresponsive, the touch-control device 500C-1 may transmit a control signal to the touch-control device 500C-2 via one or more third-party devices 510C to control the one or more endpoints 515C. Similarly, in the case that the one or more third-party devices 510 are unable to reach the local network 505, the touch-control devices 500 may be configured to communicatively couple the third-party devices 510 to the local network 505 or each other. Note that although the local network 505 has been described as being unresponsive or unreachable, this is by no means the only basis for selection of an alternative communication route. For example, communication routes may be selected on physical proximity or network traffic. In some embodiments, the touch-control devices 500 are communicatively coupled to the local network 505 using a first communication protocol, and communicatively coupled to the one or more third-party devices 510 using a second communication protocol. In these embodiments, the network traffic in the respective protocols may be more or less independent. Accordingly, communication routes may be selected or adapted even when all connections are available.

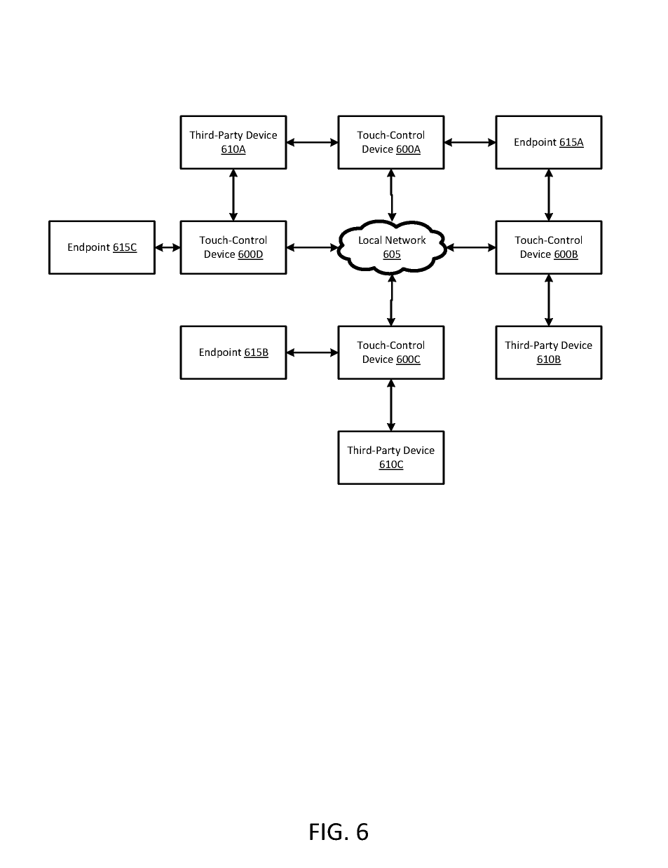

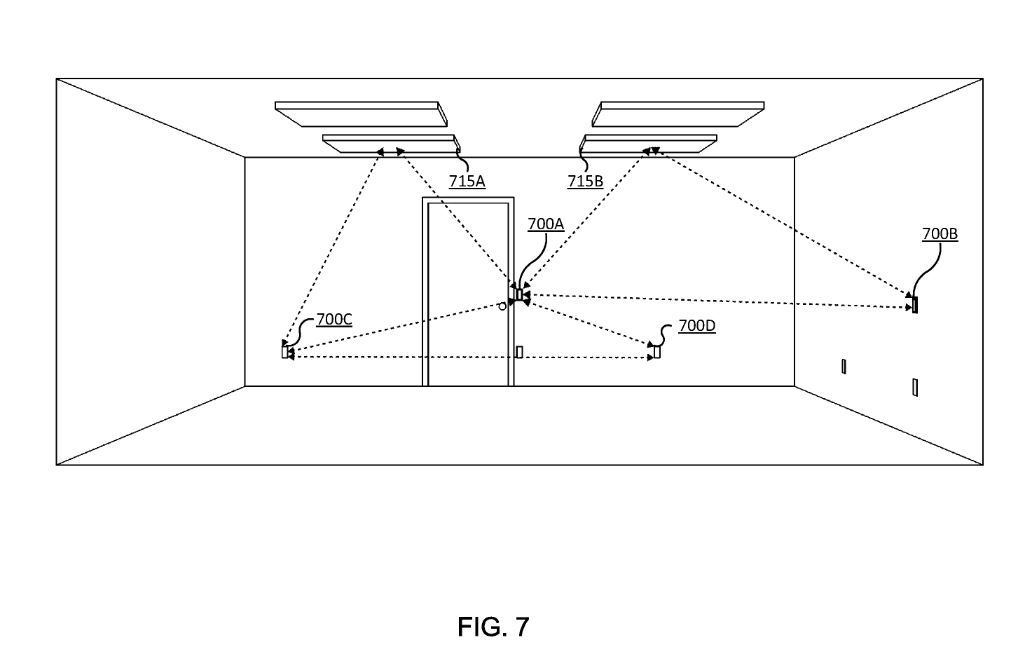

FIG. 6 generally illustrates a system of touch control devices 600 including variations of systems of touch-control devices of FIGS. 5A-5C collectively. The touch-control devices 600A-600D are communicatively coupled to a local network 605, as well as to respective third-party devices 610A-610C. The touch-control devices 600A, 600D are communicatively coupled to third-party device 610A, the touch-control device 600B is communicatively coupled to third-party device 610B, and the touch-control device 600C is communicatively coupled to the third-party device 610C. The touch-control devices 600A, 600B are electrically coupled to the endpoint 615A, the touch-control device 600C is electrically coupled to endpoint 615B, and touch-control device 600D is electrically coupled to endpoint 615C. Accordingly, any of the third-party devices 610A-610C, as well as any of the endpoints 615A-615C may be controlled from any of the touch-control devices 600A-600D. For example, endpoints 615B, 615C may be selected as target devices based on a gesture received at the touch-control device 600A, which is communicated via the local network 505 and/or a third-party device 610A. By way of additional example, the touch control devices 600A and 600B may communicate via the endpoint 615A, such as by powerline communication. Thus, a user may interact with any of the touch-control devices 600 to control any of the endpoints 615 or third-party devices 610 regardless of the arrangement of electrical coupling. Further, the touch-control devices 600 may be configured as context aware devices, as illustrated in FIG. 7.

FIG. 7 illustrates a system of touch-control devices 700A, 700B, plug-in control devices 700C, 700D, and endpoints 715A, 715B, such as 2′×4′ LED lay-in fixtures. Endpoint 715A is electrically coupled to touch-control device 700A, whereas endpoint 715B is electrically coupled to touch-control device B. Additional loads or endpoints, such as appliances, may be electrically coupled (i.e. plugged in) to the plug-in control devices 700C, 700D. The touch-control devices 700A, 700B and plug-in control devices 700C, 700D are communicatively coupled to each other, such as over a local network or direct communication. Additionally, each device 700 is contextually aware of its position relative to the other devices 700. For example, in the case that each device 700 includes a GPS sensor, absolute position may be determined individually, with relative position being inferred from the respective absolute positions of the devices 700. Alternatively, the relative positions of the devices 700 may be detected or inferred from the devices 700 themselves. For example, the devices 700 may transmit and receive wireless signals, such as acoustic or electromagnetic signals, and compare time-of-flight information. In some embodiments, wireless signal strength is used to detect or infer a relative distance. In other embodiments, an acoustic signal, such as an ultrasonic chirp, is transmitted with a predetermined intensity, and a sound pressure level is used to detect or infer a relative distance. The devices 700 may be configured to generate a relative positional arrangement upon initial installation, or may be configured to generate relative positional arrangements periodically, such as hourly, daily, or on a user-configured schedule.

The relative positional arrangements may further inform the system of an architectural layout of a room or structure. Alternatively, or in addition, a known architectural layout may be used to inform a relative positional arrangement. For example, switch boxes are typically installed at roughly 48″ above a floor, whereas receptacle boxes are typically installed at roughly 18″ above a floor. Accordingly, these values may inform a relative positional arrangement. Further, the devices 700 are configured to detect or infer a relative positional arrangement which includes the endpoints 715A, 715B. For example, the endpoint 715A may be controlled to emit a pattern of illumination which is detected by one or more of the devices 700, and from which relative distances to the respective devices 700 may be calculated. Accordingly, information regarding a layout of the room or structure may be improved.

The information regarding the layout or environment is used to improve the behavior of the devices 700. As discussed previously, a selection or control of one or more endpoints 715 may be based, at least in part, on a mapping between a gesture at a touch-control device 700A, 700B, and the environment. As illustrated in FIG. 7, the Endpoint 715A is roughly above and leftward of the touch-control device 700A. Accordingly, a gesture which is generally upward and leftward at the touch-control device 700A may be used to select the Endpoint 715A as a target device. With respect to touch-control device 700B, both endpoints 715A, 715B are upward, but at different distances from the touch-control device B. Accordingly, a user-configured gesture may be used to select either or both of the endpoints 715A and 715B as the target device. For example, a user may repeat a gesture or gestures to “scroll” through the endpoints 715A, 715B, as well as selection of both endpoints 715A, 715B. Further, it is to be understood that different positions of the touch-control devices 700A, 700B relative to the endpoint 715A means that different gestures may be used to select the same endpoint (e.g. endpoint 715A) based on which touch-control device 700A, 700B receives the gesture. That is to say, in addition to a gesture, including spatiotemporal information of the gesture, and user authorization, one or both of selection and control of one or more endpoints may be based, at least in part, on the device which receives the gesture and the endpoints to be controlled.

Selection and/or control of target devices may be improved with feedback to a user, such as a visual or audible indicator in a touch-control device. For example, a visual indicator may adjust a light intensity, a color output, or pattern of illumination. In the case of color output, a user may make adjustments with a virtual color wheel or circular gesture at a touch-input surface. In some embodiments, a visual indicator may be controlled to substantially reproduce illumination of a selected endpoint. Further, one or more selected endpoints may be controlled to produce illumination and the visual indicator may then be controller to substantially reproduce the illumination of the one or more endpoints. For example, a user may input a gesture at the touch-control device 700B to select endpoint 715A as the target device. In this example, the endpoint 715A is controlled to strobe on and off at a predetermined frequency. The visual indicator of the touch-control device 700B is then controlled to illuminate in a similar color as the Endpoint 715A (e.g. 5000K) at the predetermined frequency. Accordingly, it may be readily understood by a user which endpoint 715A is selected as a target device. However, not all users may desire strobing to indicate selection of a target device. It is to be understood that an endpoint 715 may be controlled to whichever extent the endpoint 715 is configured, and this control may be user configurable as well.

For example, in the case that endpoint 715B includes a plurality of multicolored LEDs, illumination from endpoint 715B may be controlled to vary in intensity (dimming), color, a pattern of illumination, such as strobing or other time-varying color or time-varying intensity. In this example, the visual indicator of the touch-control device 700B is controlled to produce substantially similar illumination. It is to be understood that a visual indicator may not be configured for perfectly equivalent output in color or intensity as an endpoint 715. As used herein, substantially similar indicates that there is a correspondence between illuminations from devices within the capabilities of the respective devices.

Indication need not be limited to a single pattern of illumination. As described previously, a visual indicator may include a plurality of regions configured for independent illumination. Accordingly, more than one endpoint may be simultaneously selected as target devices and controlled to produce different patterns of illumination. Accordingly, different regions of the visual indicator of the touch-control device 700B may be configured to produce substantially similar patterns of illumination corresponding to the patterns of illumination produced at the respective endpoints 715. Different patterns of illumination may vary on one or more characteristics and, further, these characteristics may vary based on, for example, an operational state of the touch-control device 700 or the respective endpoints 715. For example, two endpoints 715 may be selected as target devices and controlled to produce illumination at the same predetermined frequency. A first endpoint 715A may be controlled to produce illumination at a first intensity, whereas the second endpoint 715B may be controlled to produce illumination at a second intensity. The visual indicator of the touch-control device 700B may then be controlled to illuminate two regions of the visual indicator at different intensities corresponding to the respective endpoints 715A, 715B, while controlling both regions of the visual indicator to produce illumination at the same predetermined frequency.

Although described with the example of a visual indicator, feedback may be produced with other indicators, such as an audible indicator of the touch-control device 700A. For example, in the case that an endpoint is a speaker, the endpoint may be controlled to produce a sound having a frequency, intensity, and pattern of modulation, such as a continuous tone, melody, sequence of words, music, or any suitable sound. Accordingly, an audible indicator of the touch-control device 700A may be controlled to produce substantially similar sound. It is to be understood that an audible indicator may not be configured for perfectly equivalent output in frequency or intensity as an endpoint. As used herein, substantially similar indicates that there is a correspondence between sound from devices within the capabilities of the respective devices.

Further, indicators may be configured to map an output at an endpoint, such as illumination, to a different output at a touch-control device, such as an audible indicator. Such a mapping is inherently imperfect, but may be readily understood by a user. For example, a correspondence in intensity or pattern of illumination to intensity or pattern of sound may be readily understood to be indicative of a selection of an endpoint as a target device. Similarly, a correspondence in color (i.e. frequency of light) to a pitch (i.e. frequency of sound) may be understood to be indicative of a selection of an endpoint as a target device. For example, a rising pitch may be indicative of a change in color of light at the target device, whereas an increase in volume may be indicative of a change in intensity of light at the target device.

Although the system of FIG. 7 is illustrated in one room, it is to be understood that any number of devices 700, such as the touch-control devices 700A, 700B and plug-in control devices 700C, 700D may be communicatively coupled and used to inform both context awareness of the devices 700 themselves, as well as a layout of a larger structure. For example, a system may include all devices 700 in a home or office. The context aware touch-control devices 700 may then enable more intuitive selection and control of various endpoints, such as by location or user-configurable grouping. As these touch-control devices 700 include a plurality of sensors, a level of user-configurability is afforded that is entirely impractical with traditional switches. For example, a control to turn off the lights of all unoccupied offices and dimming hallway lights may be readily configured by a user.

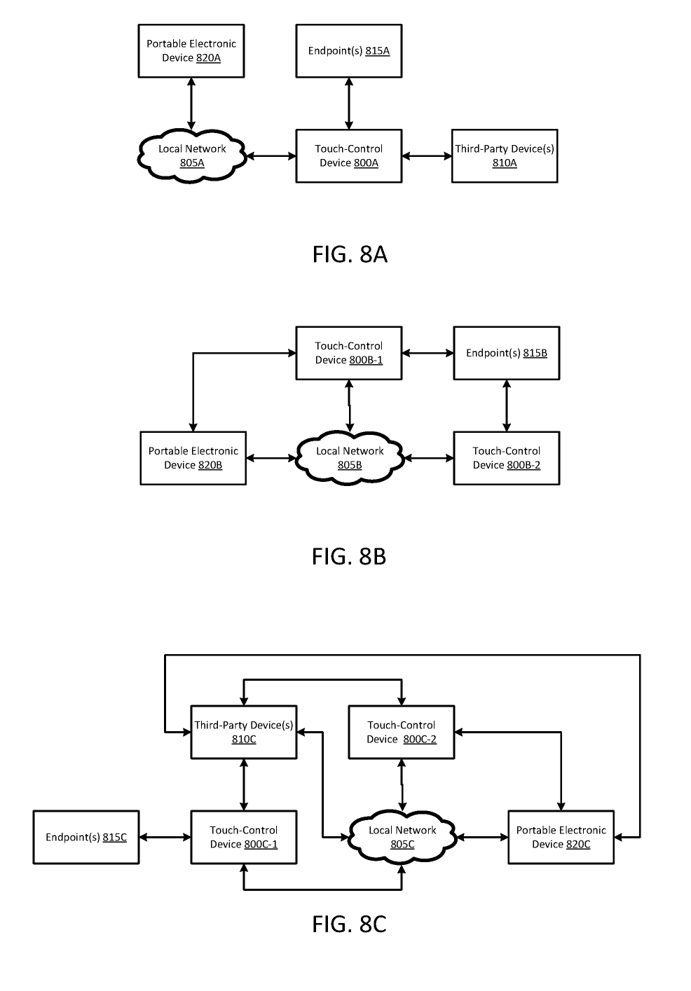

FIG. 8A illustrates one embodiment of a touch-control device 800A. The touch-control device 800A is communicatively coupled to a local network 805A, such as a Wi-Fi network, as well as one or more third-party devices 810A, such as various smart bulbs or virtual assistants. One or more endpoints 815A are electrically coupled to the touch-control device 800A. Additionally, a portable electronic device 820A, such as a tablet or smartphone, is communicatively coupled to the local network 805A. As tablets and smartphones generally have a two-dimensional touch-input surface, gestures input at the touch-control device 800A may be used directly on the touch-input surface of the portable electronic device 820A. Accordingly, the touch-control device 800A is configured to control the one or more endpoints 815A based on a gesture received at the touch-control device 800A or, for example, a control signal received from the portable electronic device 820A over the local network 805A or from one of the third-party devices 810A. Similarly, the touch-control device 800A is configured to transmit a control signal to any of the third-party devices 810A as well as over the local network 805A.

FIG. 8B illustrates an embodiment of a system of touch-control devices 800B. In this embodiment, a pair of touch-control devices 800B is electrically coupled to the same one or more endpoints 815B. For example, a pair of touch-control devices 800B may be configured as conventional three-way switches. Both touch-control devices 800B are communicatively coupled to a local network 805B. Additionally, a portable electronic device 820B, such as a tablet or smartphone, is communicatively coupled to the local network 805B and the touch-control device 800B-1. As tablets and smartphones generally have a two-dimensional touch-input surface, gestures input at the touch-control device 800B-1, 800B-2 may instead be used directly on the portable electronic device 820B. Accordingly, the pair of touch-control devices 800B is configured to control the one or more endpoints 815B based on a gesture received at either of the touch-control devices 800B or, for example, a control signal received over the local network 805B, such as a gesture received at the portable electronic device 820B. Similarly, the touch-control devices 800B are configured to transmit a control signal over the local network.

FIG. 8C illustrates another embodiment of a system of touch-control devices 800C. In this embodiment, two touch-control devices 800C are communicatively coupled to a local network 805C and one or more third-party devices 810C. The one or more third-party devices 810C and a portable electronic device 820C are also communicatively coupled to the local network 805C. Additionally, the touch-control device 800C-1 is electrically coupled to one or more endpoints 815C. Accordingly, the one or more endpoints 815C may be controlled based on a gesture received at either of the touch-control devices 800C or the portable electronic device 820C. For example, after a gesture is received at the touch-control device 800C-2, a control signal is transmitted via the local network 805C to the touch-control device 800C-1 to control the one or more endpoints 815C.

Additionally, the connections amongst the touch-control devices, one or more third-party devices, and the local network may provide improved network resiliency. For example, in the case that the local network is unresponsive, the touch-control device 800C-2 may transmit a control signal to the touch-control device 800C-1 via one or more third-party devices 810C to control the one or more endpoints 815C. Similarly, in the case that the one or more third-party devices 810C are unable to reach the local network 805C, the touch-control devices 800C may be configured to communicatively couple the third-party devices 810C to the local network 805C. Note that although the local network 805C has been described as being unresponsive or unreachable, this is by no means the only basis for selection of an alternative communication route. For example, communication routes may be selected on physical proximity or network traffic. In some embodiments, the touch-control devices 800C are communicatively coupled to the local network 805C using a first communication protocol, and communicatively coupled to the one or more third-party devices 810C using a second communication protocol. In these embodiments, the network traffic on the respective protocols may be more or less independent. Accordingly, communication routes may be selected or adapted even when all connections are available.

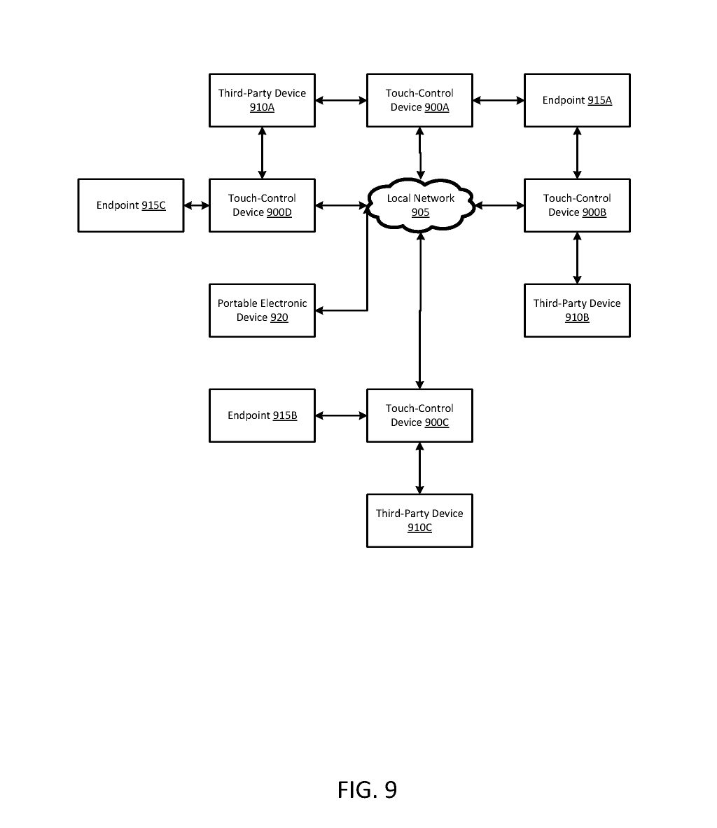

FIG. 9 generally illustrates a system including variations of the touch-control devices of FIGS. 8A-8C collectively. The touch-control devices 900 are communicatively coupled to a local network 905, as well as to respective third-party devices 910. The touch-control devices 900A, 900D are communicatively coupled to third-party device 910A, the touch-control device B is communicatively coupled to third-party device 910B, and the touch-control device 900C is communicatively coupled to the third-party device 910C. Additionally, a portable electronic device 920, such as a tablet or smartphone, is communicatively coupled to the local network 905 and/or any of the touch-control devices 900 directly. As tablets and smartphones generally have a two-dimensional touch-input surface, gestures input at a touch-control device may instead be used directly on the portable electronic device 920. The touch-control devices 900A, 900B are electrically coupled to the endpoint 915A, touch-control device 900C is electrically coupled to endpoint 915B, and touch-control device 900D is electrically coupled to endpoint 915C. Accordingly, any of the third-party devices 910, as well as any of the endpoints 915 may be controlled from any of the touch-control devices 900 or the portable electronic device 920. For example, endpoints 915B, 915C may be selected as target devices based on a gesture received at the touch-control device 900A and communicated via the local network 905 and/or a third-party device 910A. By way of additional example, touch control devices 900A and 900B may communicate via the endpoint 915A, such as by powerline communication. Thus, a user may interact with any of the touch-control devices 900 to control any of the endpoints 915 or third-party devices 910 regardless of the arrangement of electrical coupling. Further, the touch-control devices 900 and portable electronic device 920 may be configured as context aware devices, as illustrated in FIG. 10.

FIG. 10 illustrates a system of touch-control devices 1000A, 1000B, plug-in control devices 1000C, 1000D, and endpoints 1015A, 1015B, such as 2′×4′ LED lay-in fixtures. Endpoint 1015A is electrically coupled to touch-control device 1000A, whereas endpoint 715B is electrically coupled to touch-control device B. Additional endpoints or loads, such as appliances, may be electrically coupled (i.e. plugged in) to the plug-in control devices 1000C, 1000D. The touch-control devices 1000A, 1000B and plug-in control devices 1000C, 1000D are communicatively coupled to each other, such as over a local network or direct communication. A portable electronic device 1020, such as a tablet or smartphone, is communicatively coupled to the local network. As tablets and smartphones generally have a two-dimensional touch-input surface, gestures normally input at a touch-control device may be used directly on the portable electronic device 1020. Additionally, each device 1000, 1020 is contextually aware of its position relative to the other devices 1000, 1020. For example, in the case that each device 1000, 1020 includes a GPS sensor, absolute position may be determined individually, with relative position being inferred from the respective absolute positions. Alternatively, the relative positions of the devices 1000, 1020 may be detected or inferred from the devices 1000, 1020 themselves. For example, the devices 1000, 1020 may transmit and receive wireless signals, such as acoustic or electromagnetic signals, and compare time-of-flight information. In some embodiments, wireless signal strength is used to detect or infer a relative distance. In other embodiments, an acoustic signal, such as an ultrasonic chirp, is transmitted with a predetermined intensity, and a sound pressure level is used to detect or infer a relative distance. The devices 1000 may be configured to generate a relative positional arrangement upon initial installation. Alternatively, the devices 1000, 1020 may be configured to generate relative positional arrangements periodically, such as hourly, daily, on a user-configured schedule, or in response to a detected movement, such as a change in position of the portable electronic device 1020.

The relative positional arrangements may further inform the system of an architectural layout of a room or structure. Alternatively, or in addition, a known architectural layout may be used to inform a relative positional arrangement. For example, switch boxes are typically installed at roughly 48″ above a floor, whereas receptacle boxes are typically installed at roughly 18″ above a floor. Accordingly, these values may inform a relative positional arrangement. Further, the devices 1000, 1020 are configured to detect or infer a relative positional arrangement which includes the endpoints 1015. For example, the endpoint 1015A may be controlled to emit a pattern of illumination which is detected by one or more of the devices 1000, 1020, and from which relative distances may be calculated. Accordingly, information regarding a layout of the room or structure may be improved.

The information regarding the layout or environment is used to improve the behavior of the devices 1000, 1020. As discussed previously, a selection or control of one or more endpoints 1015 may be based, at least in part, on a mapping between a gesture at a touch-control device 1000 and the environment. As illustrated in FIG. 10, the endpoint 1015A is roughly above and leftward of the touch-control device 1000A. Accordingly, a generally obliquely upward and leftward gesture at the touch-control device 1000A may be used to select the endpoint 1015A as a target device. With respect to touch-control device 1000B, both endpoints 1015 are upward, but at different distances from the touch-control device 1000B. Accordingly, a user-configured gesture may be used to select either or both of the endpoints 1015 as the target device. Further, it is to be understood that different positions of the touch-control devices 1000A, 1000B relative to the endpoint 1015A means that different gestures may be used to select the same endpoint (e.g. endpoint 1015A) based on which touch-control device receives the gesture. Context awareness may be particularly beneficial to interpreting gestures received at the portable electronic device 1020. The portable electronic device 1020 includes accelerometers which inform not only the position of the device 1020, but also the orientation. That is to say, in addition to a gesture, including spatiotemporal information of the gesture, and user authorization, one or both selection and control of one or more endpoints may be based, at least in part, on the device which receives the gesture and the endpoints to be controlled.

The information regarding the layout or environment may further be used to improve the behavior of the devices 1000 based on traffic patterns within the environment. As the majority of persons regularly carry an electronic device with them, the devices 1000 may yield information related to user activities within the environment. Further, the devices 1000 may provide feedback to a user in the environment, such as using visual or audible indicators to aid navigation. In an emergency situation, devices 1000 could be illuminated to communicate safe or obstructed paths of egress to users within the environment. To continue the emergency situation example, the devices 1000 may detect locations of electronic devices, such as portable electronic devices 1020, associated with users in the environment and communicate them to the first responders.

Selection and/or control of target devices may be improved with feedback to a user, such as a visual or audible indicator in a touch-control device 1000 or the portable electronic device 1020. For example, a visual indicator may adjust a light intensity, a color output, or pattern of illumination. In some embodiments, a visual indicator may be controlled to substantially reproduce illumination of a selected endpoint. Further, one or more selected endpoints 1015 may be controlled to produce illumination and the visual indicator may then be controlled to produce substantially similar illumination. For example, a user may input a gesture at the portable electronic device 1020 to select endpoint 1015A as the target device. In this example, the endpoint 1015A is controlled to strobe on and off at a predetermined frequency. Additionally, a visual indicator, such as a display screen of the portable electronic device 1020 is controlled to illuminate in a similar color as the endpoint 1015A (e.g. 2300K) at the predetermined frequency. Accordingly, it may be readily understood by a user which endpoint 1015 is selected as a target device. However, not all users may desire strobing to indicate selection of a target device. It is to be understood that an endpoint 1015 may be controlled to whichever extent the endpoint 1015 is configured, and this control may be user configurable as well. A user may configure the endpoints into respective groups or zones, configure various control modes, and configure mappings between respective gestures and controls or scripts at a touch-control device 1000, or at a networked device, such as a computer or portable electronic device 1020.

For example, in the case that endpoint 1015B includes a plurality of multicolored LEDs, illumination from endpoint 1015B may be controlled to vary in intensity (dimming), color, a pattern of illumination, such as strobing or other time-varying color or intensity. In this example, the visual indicator of touch-control device 1000B would be controlled to produce substantially similar illumination. It is to be understood that a visual indicator may not be configured for perfectly equivalent output in color or intensity as an endpoint. As used herein, substantially similar indicates that there is a correspondence between illumination from respective devices within the capabilities of the devices.

Indication need not be limited to a single pattern of illumination. As described previously, a visual indicator may include a plurality of regions configured for independent illumination. Accordingly, more than one endpoint 1015 may be simultaneously selected as target devices and controlled to produce different patterns of illumination. Accordingly, different regions of the visual indicator of the portable electronic device 1020 may be configured to produce substantially similar patterns of illumination corresponding to the patterns of illumination produces at the respective endpoints. Different patterns of illumination may vary on one or more characteristics and, further, these characteristics may vary based on, for example, an operational state of the touch-control device 1000, the portable electronic device 1020, or the respective endpoints 1015. For example, two endpoints 1015 may be selected as target devices and controlled to produce illumination at the same predetermined frequency. A first endpoint 1015A may be controlled to produce illumination at a first intensity, whereas the second endpoint 1015B may be controlled to produce illumination at a second intensity. The visual indicator of the portable electronic device 1020 may then be controlled to illuminate two regions of the visual indicator at different intensities corresponding to the respective endpoints, while controlling both regions to produce illumination at the same predetermined frequency. Further, as the position or orientation of the portable electronic device 1020 may change, the position and/or orientation of the regions may be adapted in real-time.

Although described with the example of a visual indicator, similar feedback may be produced with other indicators, such as a speaker of the portable electronic device 1020. For example, in the case that an endpoint is a speaker, the endpoint may be controlled to produce a sound having a frequency, intensity, and pattern of modulation, such as a continuous tone, melody, sequence of words, music, or any suitable sound. Accordingly, the speaker of the portable electronic device 1020 may be controlled to produce substantially similar sound. It is to be understood that a speaker may not be configured for perfectly equivalent output in frequency or intensity as an endpoint. As used herein, substantially similar indicates that there is a correspondence between sound from respective devices within the capabilities of the devices.

Further, indicators may be configured to map an output at an endpoint, such as illumination, to a different output at a portable electronic device 1020, such as an tactile or vibration indicator. Such a mapping is inherently imperfect, but may be readily understood by a user. For example, a correspondence in intensity or pattern of illumination to intensity or pattern of vibration may be readily understood to be indicative of a selection of an endpoint as a target device. Similarly, a correspondence in color (i.e. frequency of light) to frequency of vibration may be understood to be indicative of a selection of an endpoint as a target device.

Although the system of FIG. 10 is illustrated in one room, it is to be understood that any number of devices, such as the touch-control devices 1000A, 1000B and plug-in control devices 1000C, 1000D may be communicatively coupled and used to inform both context awareness of the devices 1000 themselves, as well as a layout of a larger structure. For example, a system may include all touch-control devices 1000 in a home or office. The context aware devices 1000, 1020 may then enable more intuitive selection and control of various endpoints 1015, such as by location or user-configurable grouping. As these touch-control devices 1000, 1020 include a plurality of sensors, a level of user-configurability is afforded that is entirely impractical with traditional switches. For example, a control to turn off the lights of all unoccupied offices and dimming hallway lights may be configured by a user at the portable electronic device 1020.

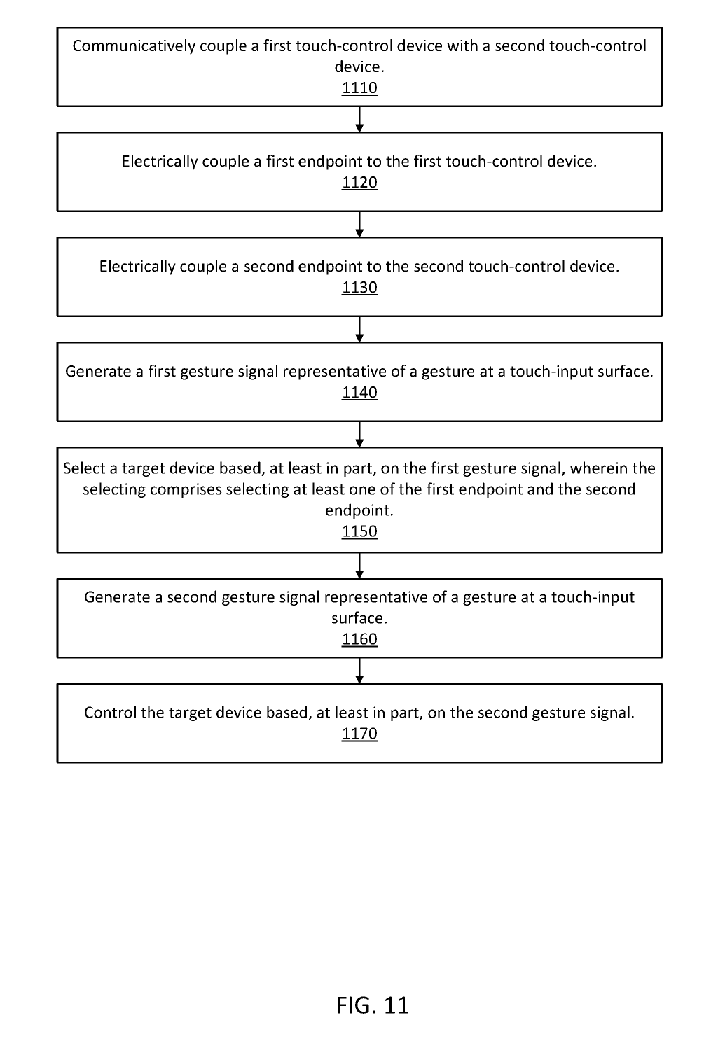

FIG. 11 a flow diagram of a method of selecting a target device at a touch-control device. At step 1110, a first touch-control device is communicatively coupled with a second touch-control device, for example using wireless communication. At step 1120, a first endpoint is electrically coupled to the first touch-control device. At step 1130, a second endpoint is coupled to the second touch-control device. At step 1140, a first gesture signal is generated. The first gesture signal is representative of a gesture at a touch-input surface, such as a touch-input surface of the first or second touch-control devices. At step 1150, a target device is selected based, at least in part, on the first gesture signal. The selection of the target device includes selecting at least one of the first endpoint and the second endpoint. At step 1160, a second gesture signal is generated. The second gesture signal is representative of a gesture at a touch-input surface. At step 1170, the target device is controlled based, at least in part, on the second gesture signal.

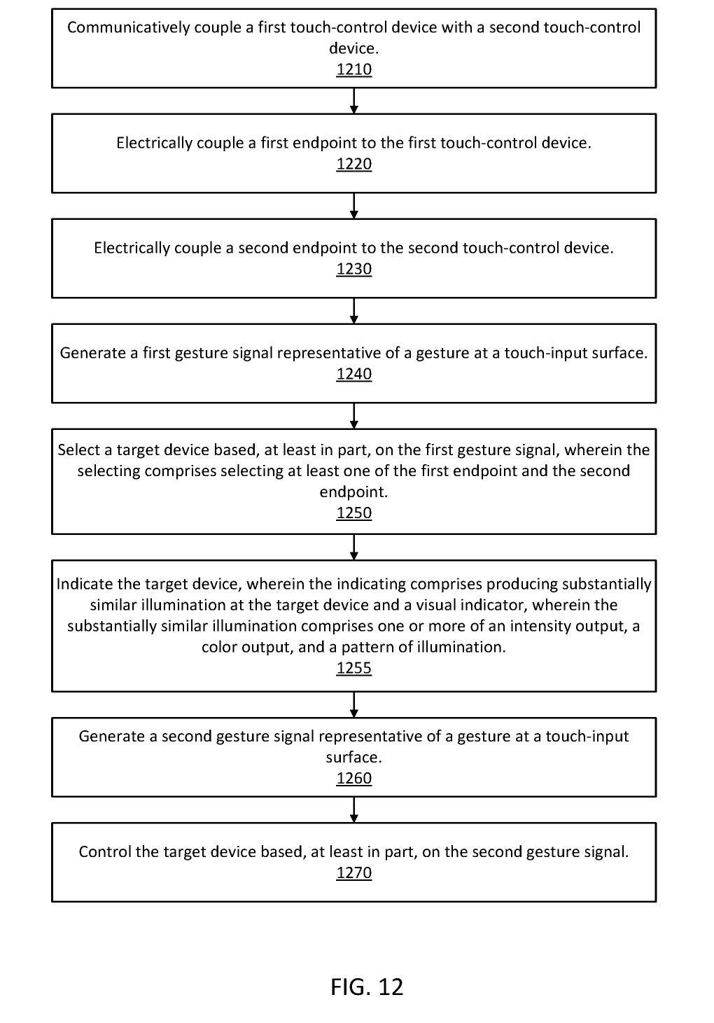

FIG. 12 is a flow diagram of a method of configuring an indication at a control device. At step 1210, a first touch-control device is communicatively coupled with a second touch-control device, for example using wireless communication. At step 1220, a first endpoint is electrically coupled to the first touch-control device. At step 1230, a second endpoint is coupled to the second touch-control device. At step 1240, a first gesture signal is generated. The first gesture signal is representative of a gesture at a touch-input surface, such as a touch-input surface of the first or second touch-control devices. At step 1250, a target device is selected based, at least in part, on the first gesture signal. The selection of the target device includes selecting at least one of the first endpoint and the second endpoint. At step 1255, the target device is indicated by producing substantially similar illumination at the target device and a visual indicator. The visual indicator may be controlled to produce illumination substantially similar to the target device, or both the target device and the visual indicator may be simultaneously controlled to produce substantially similar illumination. The substantially similar illumination may include one of more of an intensity output, a color output, and a pattern of illumination. At step 1260, a second gesture signal is generated. The second gesture signal is representative of a gesture at a touch-input surface. At step 1270, the target device is controlled based, at least in part, on the second gesture signal.

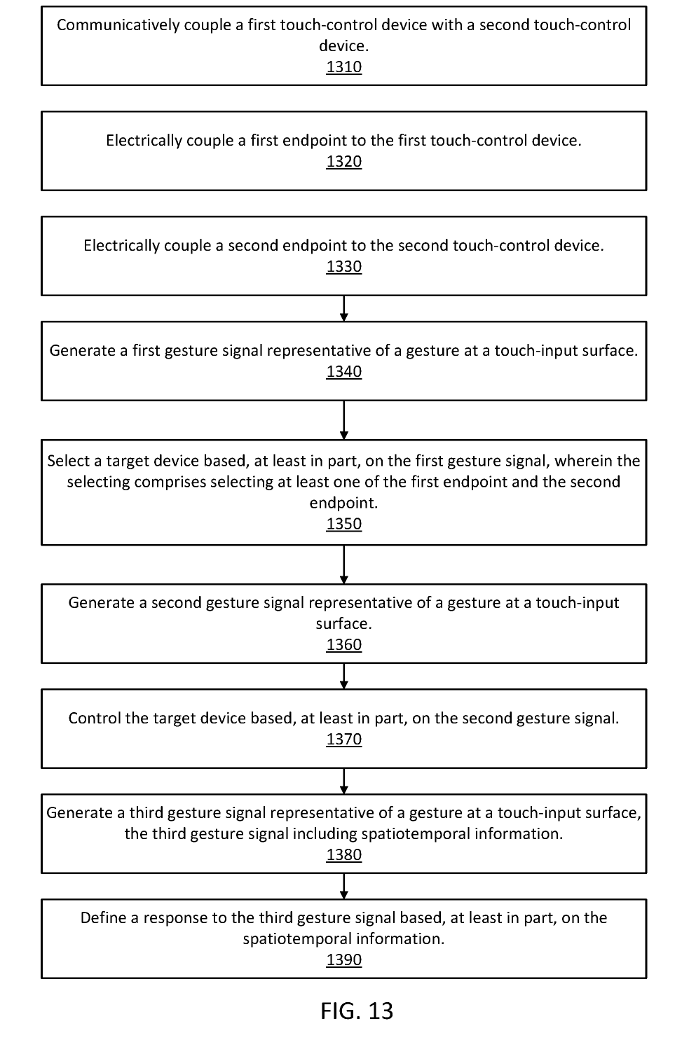

FIG. 13 is a flow diagram of a method of defining a user-configured response. At step 1310, a first touch-control device is communicatively coupled with a second touch-control device, for example using wireless communication. At step 1320, a first endpoint is electrically coupled to the first touch-control device. At step 1330, a second endpoint is coupled to the second touch-control device. At step 1340, a first gesture signal is generated. The first gesture signal is representative of a gesture at a touch-input surface, such as a touch-input surface of the first or second touch-control devices. At step 1350, a target device is selected based, at least in part, on the first gesture signal. The selection of the target device includes selecting at least one of the first endpoint and the second endpoint. At step 1360, a second gesture signal is generated. The second gesture signal is representative of a gesture at a touch-input surface. At step 1370, the target device is controlled based, at least in part, on the second gesture signal. At step 1380, a third gesture signal is generated. The third gesture signal is representative of a gesture at a touch-input surface, and the third gesture signal includes spatiotemporal information. At step 1390, a response to the third gesture signal is defined based, at least in part, on the spatiotemporal information. For example, a user may define the response to the third gesture signal.

Thus, the disclosure provides, among other things, a system for controlling a plurality of endpoints. Various features and advantages of the disclosure are set forth in the following claims.

What is claimed is:

1. A touch-control device comprising:
a first load controller connectable to control a first endpoint electrically coupled to the load controller;
a touch-input surface associated with the first load controller;
a network interface communicatively coupled with a network interface of a second touch-control device, wherein the second touch-control device includes a second load controller connectable to control a second endpoint electrically coupled to the second load controller;
a processor configured to:
generate a first gesture signal representative of a first gesture at the touch-input surface,
select the second endpoint as a target device, the selecting based at least in part on the first gesture,
control the target device based, at least in part, on the first gesture signal.

2. The touch-control device of claim 1, wherein the controlling the second endpoint is based, at least in part, on an association in a memory between the first gesture and a control action directed to the second endpoint.

3. The touch-control device of claim 1, wherein the processor is further configured to control the first endpoint based, at least in part, on the first gesture signal.

4. The touch-control device of claim 1, further comprising:
a visual indicator, wherein the visual indicator is configured to indicate the target device.

5. The touch-control device of claim 4, wherein the indicating the target device includes substantially reproducing one or more of an intensity output, a color output, and a pattern of illumination of the target device.

6. The touch-control device of claim 4, wherein the processor is further configured to:
control the target device and the visual indicator to output substantially similar illumination.

7. The touch-control device of claim 1, wherein the processor is further configured to
generate spatiotemporal information of the first gesture signal, and
select the target device based, at least in part, on the spatial information of the first gesture signal.

8. The touch-control device of claim 1, wherein the processor is further configured to select at least one of the first endpoint and the second endpoint as the target device based, at least in part, on a user authorization.

9. The touch-control device of claim 1, wherein the processor is further configured to select at least one of the first endpoint and the second endpoint based, at least in part, on a user identity.

10. A system for controlling a plurality of endpoints, comprising:
a first touch-control device, including:
a first touch-input surface, and
a first load controller connectable to control an application of electrical energy to an electrically coupled device;
a first endpoint electrically coupled to the first load controller;
a second touch-control device communicatively coupled with the first touch-control device, including:
a second touch-input surface,
a second load controller connectable to control an application of electrical energy to an electrically coupled device;
a second endpoint electrically coupled to the second load controller; and
a processor configured to:
generate a first gesture signal representative of a gesture at either of the first touch-input surface and the second touch-input surface,
select a target device based, at least in part, on the first gesture signal, wherein the selecting the target device includes selecting at least one of the first endpoint and the second endpoint,
generate a second gesture signal representative of a gesture at either of the first touch-input surface and the second touch-input surface, and
control the target device based, at least in part, on the second gesture signal.

11. The touch-control device of claim 10, wherein the processor is further configured to receive an association between the first gesture and a control action associated with one or more of the plurality of endpoints.

12. The touch-control device of claim 11, wherein receiving an association between the first gesture and a control action associated with one or more of the plurality of endpoints comprises receiving user input defining at least one of the first gesture and the control action associated with one or more of the plurality of endpoints.

13. The system of claim 10, further comprising:
a visual indicator, wherein the visual indicator is configured to indicate the target device.

14. The system of claim 11, wherein the processor and the visual indicator are disposed in the first touch-control device.

15. The system of claim 10, wherein at least one of the first gesture signal and the second gesture signal comprises a user-defined gesture signal.

16. The system of claim 10, wherein the processor is further configured to:
generate spatiotemporal information of the second gesture signal, and
control the target device based, at least in part, on the spatiotemporal information of the second gesture signal.

17. The system of claim 10, wherein the processor is further configured to:
generate a third gesture signal representative of a gesture at either of the first touch-input surface and the second touch-input surface;
authorize a user based, at least in part, on the third gesture signal; and
wherein the selecting the target device is based, at least in part, on the authorizing the user.

18. A method of controlling a plurality of endpoints, comprising:
communicatively coupling a first touch-control device with a second touch-control device;
electrically coupling a first endpoint to the first touch-control device;
electrically coupling a second endpoint to the second touch-control device;
generating, with a processor, a first gesture signal representative of a gesture at a touch-input surface;
selecting a target device based, at least in part, on the first gesture signal, wherein the selecting comprises selecting at least one of the first endpoint and the second endpoint;
generating, with the processor, a second gesture signal representative of a gesture at a touch-input surface;
controlling the target device based, at least in part, on the second gesture signal.

19. The method of claim 18, further comprising
indicating the target device, wherein the indicating comprises producing substantially similar illumination at the target device and a visual indicator, wherein the substantially similar illumination comprises one or more of an intensity output, a color output, and a pattern of illumination.

20. The method of claim 18, further comprising:
generating a third gesture signal representative of a gesture at a touch-input surface, the third gesture signal including spatiotemporal information; and
defining a response to the third gesture signal based, at least in part, on the spatiotemporal information.
